(19) United States
(12) Patent Application Publication
(10) Pub. No.: US 2002/0054779 A1
(43) Pub. Date: May 9, 2002

(54) Keyboard

(75) Inventors: Chien-Shih Hsu, Taipei (TW); Chih-Hsiang Chiang, Chung-Li City (TW); Mao-Sung Huang, Chang-Hua Hsien (TW); Chin-Cheng Li, Hsin-Chuang City (TW)

Correspondence Address: Richard P. Berg, Esq., c/o LADAS & PARRY, Suite 2100, 5670 Wilshire Boulevard, Los Angeles, CA, 90036-5679, US

(73) Assignee: Darfon Electronics Corp.

(21) Appl. No.: 10/002,037

(22) Filed: Nov. 1, 2001

(30) Foreign Application Priority Data
Nov. 7, 2000 (TW) 89219313

(51) Int. Cl. B41J 5/12

(52) U.S. Cl. 400/472; 400/488

(57) ABSTRACT

A portable keyboard comprises a flexible substrate, at least two key groups disposed on the flexible substrate, a circuit board disposed on the flexible substrate, a connector electrically connected to the circuit board and a fixative element having a first connecting portion and a second connecting portion disposed on the substrate. As the flexible substrate is properly tensed to let the first connecting portion join the second connecting portion, the overlapped key groups and the circuit board are all wrapped by the flexible substrate. The folded keyboard is pocket size and easily transported and deployed.

### BACKGROUND OF THE INVENTION

1. Field of the Invention

This invention relates to a keyboard. More particularly, this invention relates to a foldable keyboard provided with a flexible substrate.

2. Description of Prior Art

Most foldable keyboards are formed in a single piece, although some are separable and some are divided into two or more pieces. Whether the keyboard is a single piece or separable, however, transportation and deployment remains an inconvenience in most cases. The two separable key pieces of foldable keyboards are folded together via a mechanical or rigid pivotal mechanism.

However, the mechanical or rigid pivotal mechanism takes up too much space and interference occurs thereof. In order to avoid the interference, the distance between the two separable key pieces and the geometric structure between the two separable key pieces and the pivotal mechanism must be exactly designed; otherwise the interference is easy to occur between the two separable key pieces.

### SUMMARY OF THE INVENTION

To solve the above problem, the primary object of this invention is to provide a foldable and easily carried keyboard. The foldable keyboard of this invention comprises a flexible substrate, at least two key groups disposed on the flexible substrate, and a fixative element disposed on the substrate so as to keep the two key groups be properly positioned by the flexible substrate.

### BRIEF DESCRIPTION OF THE DRAWINGS

The present invention can be more fully understood by reading the subsequent detailed description and examples with reference made to accompanying drawings in which:

FIG. 1 is a plan view showing the structure of a keyboard (KB) according to the present invention.

FIG. 2 is a plan view showing another state of the keyboard (KB) according to FIG. 1.

FIG. 3A is a side view according to FIG. 2.

FIG. 3B is a view showing a situation during the folding process on the keyboard (KB) according to FIG. 3A.

FIG. 3C is a view showing the folded keyboard (KB) according to FIG. 3A.

### DETAILED DESCRIPTION OF THE PREFERRED EMBODIMENTS

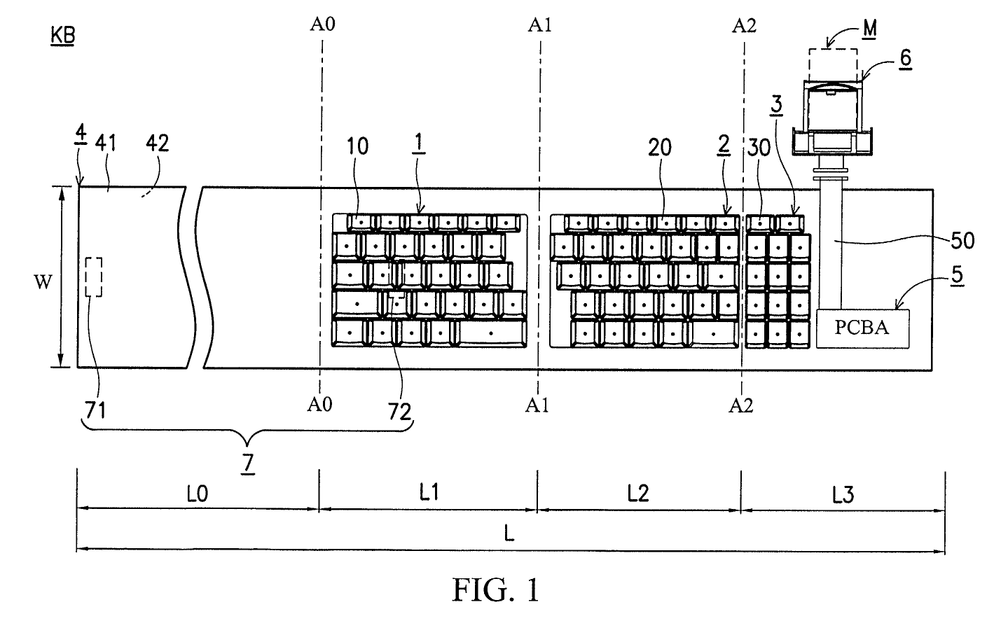

Referring to FIG. 1, a plan view shows the structure of a keyboard KB of the present invention in an open position. The keyboard KB comprises a first key group 1 composed of keys 10, a second key group 2 composed of keys 20, a third key group 3 composed of keys 30, a substrate 4 of flexible material, a circuit board 5, a connector 6 and a fixative element 7. The flexible substrate 4, a rectangular sheet in size L×W wherein “L” represents length comprised of four parts and margined by L0-L3 and “W” represents width, has a first surface 41 and a second surface 42. Preferably the flexible substrate 4 is made of leather or rubber. The first key group 1, the second key group 2 and the third key group 3 are individually disposed on the first surface 41 of the flexible substrate 4, located on the areas within margins L1, L2, L3. Three virtual axes A0-A0, A1-A1, A2-A2 are formed between margins L0 and L1, between the margins L1 and L2, and between the margins L2 and L3, respectively. The circuit board 5, electrically connected to the first key group 1, the second key group 2 and the third key group 3, is disposed on the flexible substrate 4 and next to the third key group 3, and the connector 6 used for connecting electronics such as PDA, mobile phone, etc., is electrically connected to the circuit board 5 with a lead 50. The fixative element 7 has a first connecting portion 71 and a second connecting portion 72, both disposed on the second surface 42 of the flexible substrate 4.

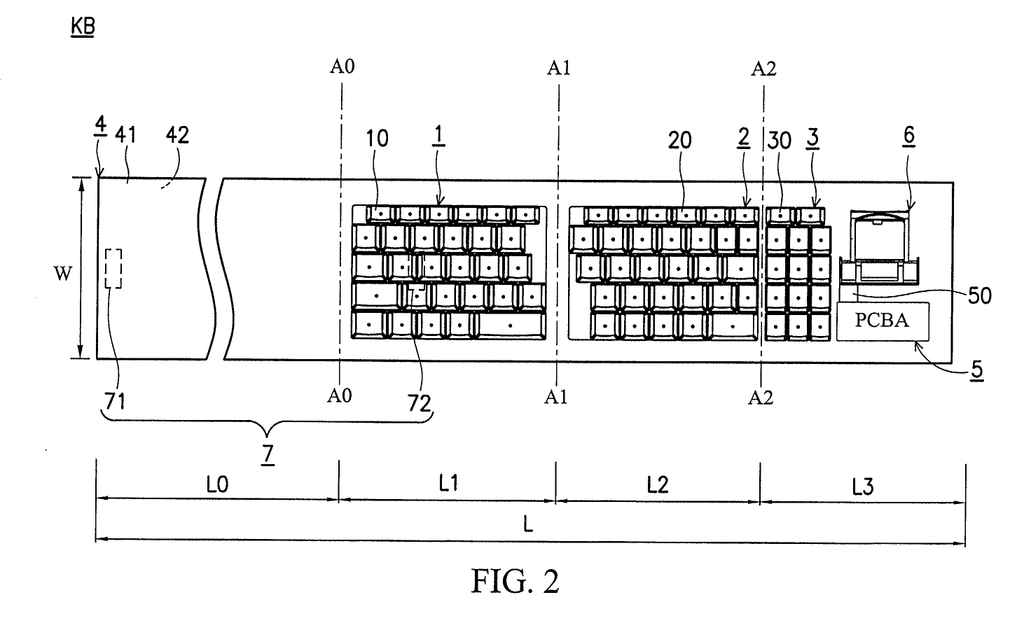

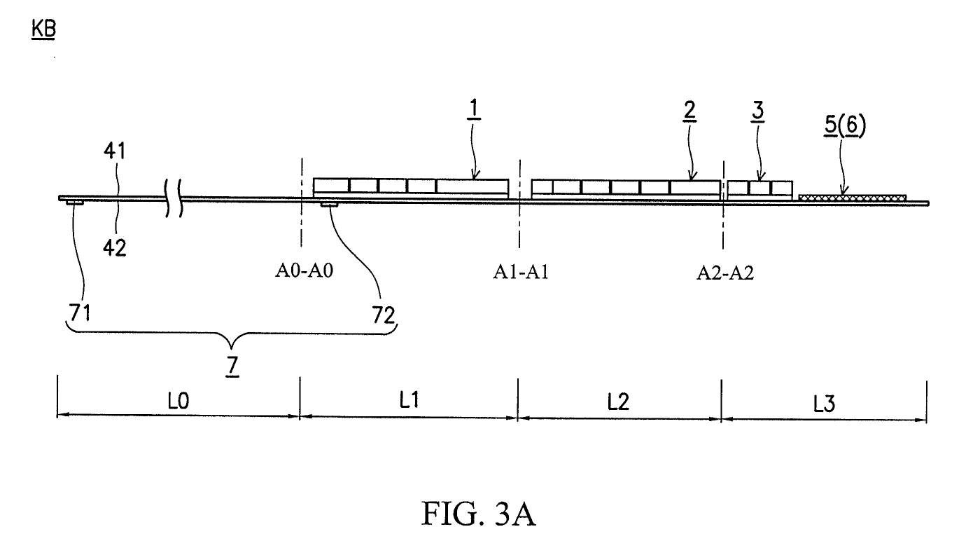

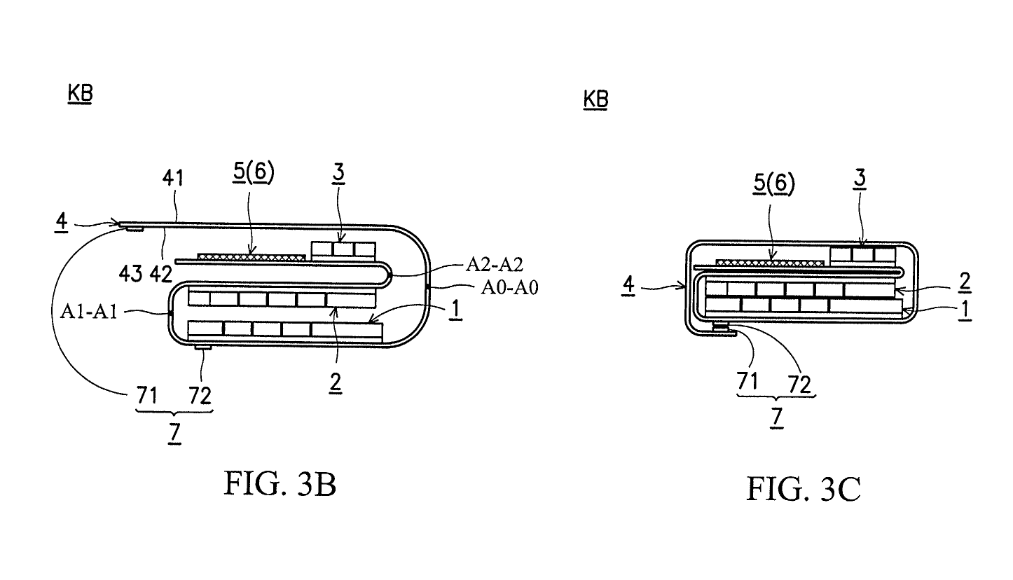

In FIG. 2, the connector 6 together with the folded lead 50 is received on the flexible substrate 4, and FIG. 3A is a side view according to FIG. 2. It is seen in FIG. 3B that the folding process on the keyboard KB is underway. The first key group 1 and the second key group 2 are moved to face each other by swiveling the flexible substrate 4 along the axis A1-A1, and the third key group 3, together with the circuit board 5 and the connector 6, is swiveled along the axis A2-A2 to approach the region of the first surface 41, directly behind the second key group 2, and then the portion of the flexible substrate 4 located with the first connecting portion 71, is swiveled along the axis A0-A0 to approach the second connecting portion 72.

FIG. 3C shows the structure of the keyboard KB which is already folded. As the flexible substrate 4 is properly tensed to let the first connecting portion 71 join with the second connecting portion 72, the overlapped first key group 1 and the second key group 2, the third key group 3, the circuit board 5 and the lead 50 are all wrapped by the flexible substrate 4.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A foldable keyboard, comprising:
a first flexibility substrate, having a first side and a second side, the flexibility substrate could be twisted in any angle;
a first key group connected to the first side of the first flexibility substrate; and
a second key group connected to the second side of the flexibility substrate and overlapped on the first key group about a virtual axis formed by the first flexibility substrate and wrapped thereby.

2. The foldable keyboard as claimed in claim 1, further comprising a flexibility circuit board mounted on the first flexibility substrate, wherein the first key group and the second key group could be connected with each other by the flexibility circuit board.

3. The foldable keyboard as claimed in claim 1, wherein the first key group further comprises a connecting portion, when the first key group is overlapped on the second key group, the second key group is fixed on the first key group by the connecting portion.

4. The foldable keyboard as claimed in claim 1, wherein the foldable keyboard further comprises a third key group and a second flexibility substrate, the third key group is selectively connected to and overlapped on the first key group or the second key group by the second flexibility substrate.

5. The foldable keyboard as claimed in claim 1, wherein the first flexibility substrate is made of leather.

6. The foldable keyboard as claimed in claim 1, wherein the first flexibility substrate is made of rubber.

7. A foldable keyboard, comprising:
a flexibility substrate having a first surface and a second surface, the flexibility substrate could be twisted in any angle;
a first key group disposed on the first surface;
a second key group disposed on the first surface and spaced apart from the first key group; and
a third key group disposed on the first surface and spaced apart from the second key group;
wherein the first key group, second key group and third key group are overlapped each other about virtual axes formed by the flexibility substrate and wrapped thereby.

8. The foldable keyboard as claimed in claim 7, further comprising a circuit board mounted on the flexibility substrate and electrically connected to the first key group, the second key group and the third key group.

9. The foldable keyboard as claimed in claim 7, further comprising a first connecting portion and a second connecting portion disposed on the substrate respectively, wherein the first connecting portion are connected to the second connecting portion while the first key group and the second key group are overlap each other and are wrapped by the flexibility substrate.

10. The foldable keyboard as claimed in claim 9, wherein the first connecting portion is disposed on the first surface and the second connecting portion is disposed on the second surface.

11. The foldable keyboard as claimed in claim 7, wherein the substrate is made of leather.

12. The foldable keyboard as claimed in claim 7, wherein the substrate is made of rubber.
